(19) United States
(12) Patent Application Publication
(10) Pub. No.: US 2010/0255155 A1
(43) Pub. Date: Oct. 7, 2010

(54) CHEESE-STUFFED PEPPERONI

(76) Inventor: Michael Stone, Pulaski, NY (US)

Correspondence Address: MARJAMA MULDOON BLASIAK & SULLIVAN LLP, 250 SOUTH CLINTON STREET, SUITE 300, SYRACUSE, NY, 13202, US

(21) Appl. No.: 12/416,578

(22) Filed: Apr. 1, 2009

(51) Int. Cl. A23L 1/31

(52) U.S. Cl. 426/92; 426/284

(57) ABSTRACT

A cheese-stuffed cured meat product is provided that comprises a three-dimensional cured meat with a hollow core opening through the cured meat and its outer surface. A cheese core is stuffed inside the cured meat to fill the hollow core. A method is also provided comprising providing a cored, cured meat product and stuffing a cheese core into the hollow portion of the cured meat product. The meat product can be manufactured with the hollow portion, or it can be cored using a coring tool.

### BACKGROUND OF THE INVENTION

This invention relates generally to the product of, and process for making cured meat products with filling, and particularly to the product of, and process for making cheese-stuffed pepperoni logs.

Cheeses and cured meats such as pepperoni are delectable treats. Pepperoni is a variety of salami made from cured and fermented meats, including, but not limited to pork, beef, and chicken. The meats are first ground and flavored with seasonings. Curing agents, such as salt and sodium nitrate, are added to prevent growth of undesirable microorganisms. Desirable bacteria are added that feed on the meats and produce lactic acid. The meat is formed, sometimes by stuffing it into casings made from animal intestines or cellulose. The bacteria ferment the meat, producing the lactic acid which lowers the pH level and helps preserve the meat. Finally, the meat is dried which further promotes preservation, and also hardens the salami. Both the fermentation and drying times can be varied to obtain varying characteristics and flavors.

The process results in a hardened meat product, meaning the final product is harder than the ground meat mixture before curing and drying. Generally, salami is shaped cylindrically because the casings into which the meat is packed for curing is cylindrically shaped. However, salami can conceivably be shaped in a variety of solid, three-dimensional shapes. For instance, a cylindrically shaped cured meat might have rounded ends. Alternatively, the cylinder might have a slight curvature, be fully round, or be curved somewhere between. In other examples, the cylinder might instead be a long solid rectangle, square, or triangle.

An abundance of cheese varieties are known. Generally, cheese is made from curdling milk. Milk can naturally curdle, but the curdling process can be accelerated using an enzyme called rennet that contains an active enzyme rennin. The curdling process separates curds from whey. At this stage, the cheese is known as cottage cheese. To continue processing the cheese into a harder cheese, such as cheddar, swiss, mozzarella, provolone, or a large variety of other cheeses, curds can be pressed to remove any residual whey and water. At this point, cheeses can undergo a variety of processes to achieve particular flavors, but simply aging the cheese will allow it to harden. The acidity of cheese kills bacteria but leaves flavor-adding molds.

The simultaneous use of cheese and cured meats yields a desirable flavor. Hence, they have been used simultaneously as ingredients in food items. On pizza and in calzones, for instance, both cheese and pepperoni are common toppings. A recipe has been published for bread infused with both cheddar cheese and turkey pepperoni. http://find.myrecipes.com/recipes/recipefinder.dyn?action=displayRecipe&recipe_id=222395, accessed Mar. 11, 2009. These foods package cheese and pepperoni as garnishments or flavor enhancers to the main ingredients. However, cured meats and cheeses are desirable together as the main ingredients.

One desirable way to eat cheese and cured meat as the main ingredients is by slicing each one separately and placing them together. Gift boxes often package a brick of cheese along with a log of pepperoni or sausage, making it convenient to slice and serve one of the cured meats with the cheese. This form of eating cheese and cured meat together allows one to savor the desired combination and level of flavors without additional unwanted ingredients, or with additional garnishments added to suit one's taste. However, extra work and mess is involved slicing the cheese and cured meat separately. Presenting and/or handling the meat and cheese slices can be messy or awkward as well when combining them to be eaten together.

Similar to being used as a garnishment or topping, cheese has also generally been used as a filling. For instance, U.S. Pat. No. 4,463,021 discloses a hand-held edible pizza cone having filling therein, where both cheese and pepperoni are possible fillings. The cone is constructed of a dough-like material. U.S. Pat. No. 5,312,633 discloses a “method of making a substantially elongated soft pretzel product from pretzel dough with the end product having an edible filling”. The edible filling can comprise meat and/or cheese. U.S. Pat. No. 6,210,723 discloses “a baked food product comprised of a yeast-leavened, bread-like crust completely enrobing a cheese filling.” Each of these products consists of some form of bread easily shaped around a filling, or easily shaped for the filling to be placed therein. Furthermore, as in previous examples contained herein, they do not focus on the preferable combination of the cured meat with the cheese as the main ingredients.

It would be advantageous to package cured meat simultaneously with cheese, in a desired ratio, so that slices of cured meat and cheese can be eaten together, without extra unwanted ingredients, and without requiring the additional work of slicing the meat and cheese separately and then placing the slices together to be eaten. It would furthermore be advantageous to eliminate extra packaging necessary to individually wrap cured meat and cheese.

### BRIEF DESCRIPTION OF THE INVENTION

In one embodiment, a cured meat product is provided, hollowed of its core, and stuffed with cheese.

In another embodiment, a method is provided to make a cured meat product stuffed with cheese. A coring tool is pressed into the cured meat to cut out a meat core. The meat core is removed, and cheese is stuffed in the hollowed core.

### BRIEF DESCRIPTION OF THE DRAWINGS

FIG. 1 is a perspective view illustrating a cheese-stuffed cured meat according to one embodiment of the invention.

FIG. 2 is a perspective view illustrating a cured meat stick, according to one embodiment of the invention.

FIG. 3 is a perspective view illustrating a cured meat stick, according to one embodiment of the invention, with cured meat stick ends cut away from a single cured meat stick segment.

FIG. 4 is a perspective view illustrating a cured meat stick, according to one embodiment of the invention, with the cured meat stick ends cut away and the cured meat stick cut into three cured meat stick segments.

FIG. 5 is a perspective view illustrating a coring tool positioned to cut into a solid pepperoni log, according to one embodiment of the invention.

FIG. 6 is a perspective view illustrating a cheese brick and a cheese core, according to one embodiment of the invention

### DETAILED DESCRIPTION OF THE INVENTION

A cheese-stuffed cured meat product is presented. While the particular schematics and related discussion exemplify pepperoni and a cheese-stuffed pepperoni log for ease of explanation, another cured meat and cured meat product can be suitable. For instance, other meats from the salami family and varieties of precooked or cured sausage are conceived as viable alternatives for the present invention. Additionally, the cured meat product can be shaped other than as a log. For instance, a curved log or a rectangular cube would be suitable. Any three-dimensional shape with a center capable of hollowing can be suitable as the product. One of ordinary skill in the art will recognize viable alternative cured, smoked, or dried meat products and their shapes. Therefore, “cured meat” and “product” can be substituted herein, respectively, where “pepperoni” and “log” are exemplified.

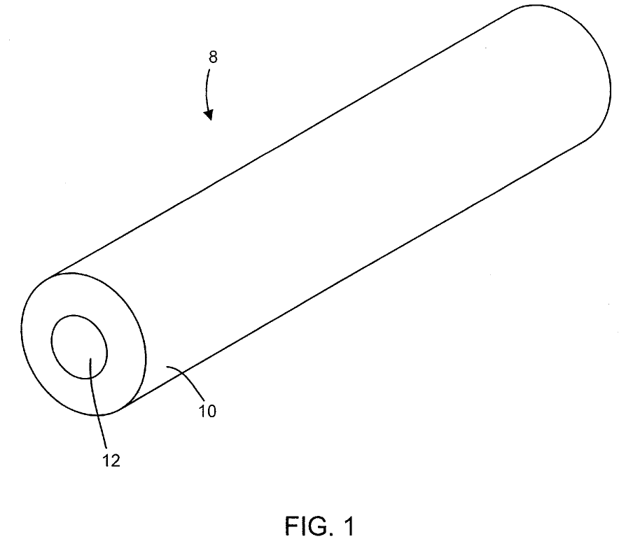

Referring to FIG. 1, the cheese-stuffed pepperoni log 8 has a cored pepperoni log 10 whose meat core has been replaced by a cheese core 12. The cheese core 12 is created inside the cored pepperoni log 10 by hollowing or coring a pepperoni stick, and inserting a cheese log or cheese segments into the cored pepperoni log 10.

The cored pepperoni log 10 can be of various lengths. The cored pepperoni log 10 depicted is eight inches long, but it can conceivably be any length short enough to be hollowed and long enough to hold a cheese core 12. The diameter can also vary, conceivably to the practical limits of eating the food. The cored pepperoni log 10 depicted is a standard or common size—approximately 1.5 inches in diameter, plus or minus 0.25 inches. The diameter can also vary depending on the particular meat used and/or standard packaging sizes of those meats.

The ends of the cored pepperoni log 10 can be flat, as shown in FIG. 1. Obtaining flat ends might require cutting the ends. Alternatively, the ends may be left rounded or in their natural shape. At least one end must be cored to insert the cheese core 12. However, while the hollowed portion of the cored pepperoni log 10 can run the full length and break through the opposite end, it can also run just a portion of the length of the cored pepperoni log 10.

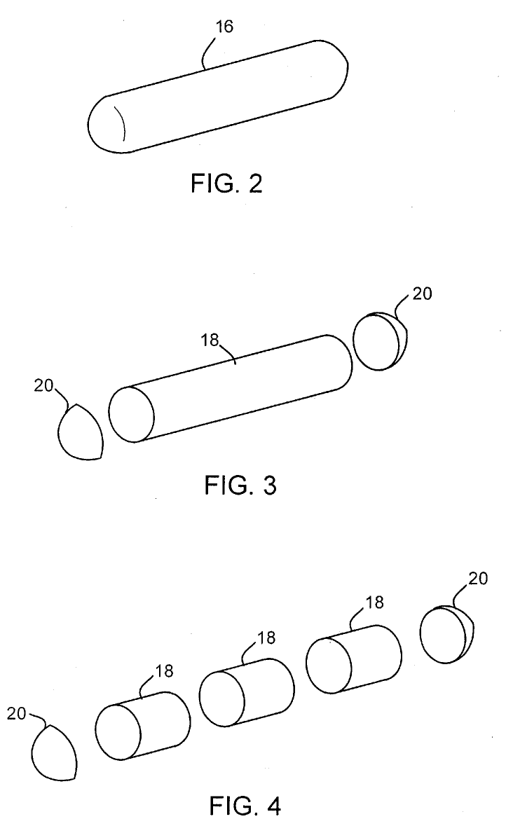

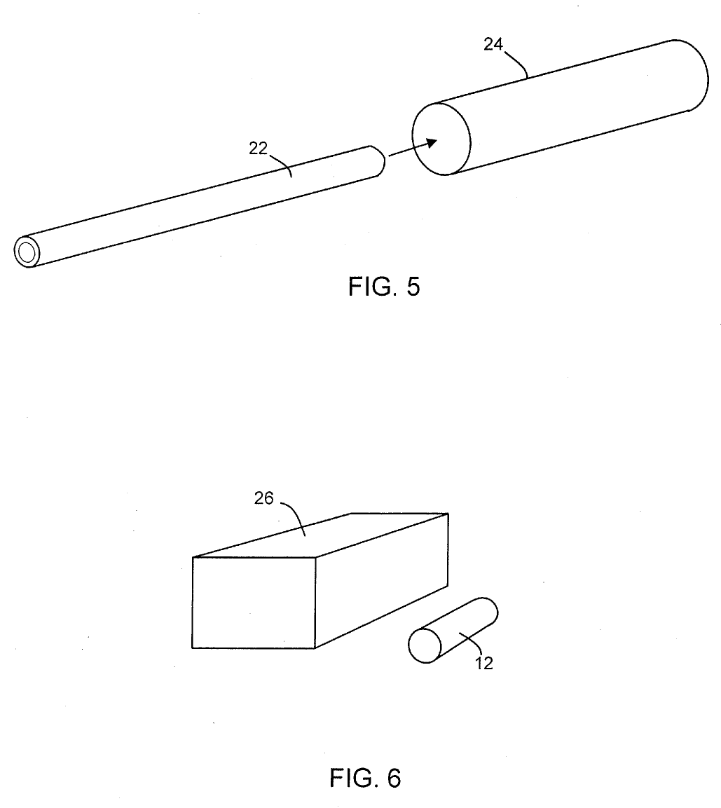

The cheese-stuffed pepperoni log 8 of FIG. 1 is created by first providing a cored pepperoni log 10. A cored pepperoni log 10 is created from a solid pepperoni log 24, depicted in FIG. 5. A standard pepperoni stick 16, depicted in FIG. 2, can be purchased pre-made, and it can suffice as the solid pepperoni log 24 of FIG. 5. One or both pepperoni stick ends 20, if desired, can be removed by cutting them off, leaving a single pepperoni stick segment 18, as depicted in FIG. 3. This pepperoni stick segment 18 can suffice as the solid pepperoni log 24 of FIG. 5. Otherwise, if desired, the pepperoni stick 16 can be cut into further pepperoni stick segments 18, as depicted in FIG. 4. For instance, a pepperoni stick 16 measuring approximately 24 inches in length after having its ends removed might be cut into three segments, each approximately eight inches long. These segments can each be a solid pepperoni log 24 of FIG. 5.

Next, as depicted in FIG. 5, a solid pepperoni log 24 is cored, or hollowed, to achieve the cored pepperoni log 10 shown in FIG. 1. A coring tool 22 is used for this step. The coring tool 22 can be as simple as a food grade stainless steel pipe. An example of such a pipe to core a 1.5 inch diameter solid pepperoni log 24 might have an outer diameter of approximately 0.875 inches and an inner diameter of approximately 0.8 inches. The pipe can be modified with sharpened edges, a handle, and/or other useful features to assist in coring. The coring tool 22 is pressed and/or twisted into the pepperoni stick segment 18 to cut the cylindrical core of meat away from the rest of the solid pepperoni log 24. The coring tool 22 can be pushed all the way through the solid pepperoni log 24 so it exits the opposite side, or it can be pushed through to a desirable length, including all the way through, and pulled out the same side from which it entered. If the cut meat core does not exit with the coring tool 22, then it can be removed otherwise. For instance, it can be pushed out with some form of poker (not shown), such as a rod, or by gripping the meat core and pulling it out, either with a gripping tool or by hand.

Both the solid pepperoni log 24 and the coring tool 22 can be varied in length and diameter to achieve a desired appearance, presentation, and taste. Furthermore, an aspect of the coring tool 22 can be integrated with a coring machine (not shown), which can speed the coring process. The coring machine can queue multiple solid pepperoni logs 24, guide them into a coring position, press the coring tool 22 into and out of a solid pepperoni log 24 at the coring position, and eject the cut meat core and the cored pepperoni log 10. The coring machine can be a pineapple corer modified to core cured meat such as a solid pepperoni log 24. The pineapple corer can be modified, for instance, to equip an embodiment of the coring tool 22. Other modifications can include, but are not limited to the addition of rails to add stability during the coring process, and the addition of a holder or guide to help queue and load solid pepperoni logs 24 into the coring position. One such pineapple corer that can be modified to be a cured meat coring machine is the Healix EZ-Cut II pineapple corer.

It is not beyond the scope of the present process to provide the solid pepperoni log 24 by alternatively preparing it from scratch. The process for making pepperoni logs from scratch is well known. If made from scratch, the pepperoni log 24 can alternatively be shaped as a cored pepperoni 10 before it is cured and dried. A casing can be appropriately shaped to hold ground meat used to make cured meat products such as pepperoni. An appropriate shape would have a void in the center and an opening into the void, just as would be created by coring the solid pepperoni log 24. If the cored cured meat is provided in this manner, coring the cured meat with the coring tool 22 can be unnecessary.

Next, a cheese core is provided. A great multitude of cheeses are known, as well as the processes to make them. The types of cheeses that can be used to make a cheese core are far too abundant to list, especially since there are almost endless combinations of flavorings, like jalapenos, prosciutto, and bacon that can added to cheese types. However, some of the more common cheeses include, but are not limited to mozzarella, cheddar, swiss, provolone, munster, gouda, American, parmesan, roman, asiago, gruyere, Jarlsberg, Colby, Monterey jack, Asadero, Quesa Fresca, mascarpone, and fontina.

Conceivably included in this process is the step of making cheese. However, as making cheese is a well known step, it is not described here. Alternatively, as illustrated in the schematic FIG. 6, a cheese brick 26 can be purchased that is large enough from which to remove a section approximately equal in diameter to that of the core of the cored pepperoni 10. For instance, for a cored pepperoni log 10 with an inner diameter equal to 0.876 inches, a cheese core might have an outer diameter equal to 0.875 inches. The cheese brick 26 can be cut, ground, extruded, or otherwise processed to remove one or more cheese cores 12 at an appropriate shape and at appropriate dimensions. The shape can generally correspond to that of the core of the cored pepperoni 10. The cored pepperoni 10, or other meat, as stated above, can be shaped other than a simple cylinder. The cheese core 12 can be shaped to match. Also, alternatively, the cheese core 12 can be segmented. The cheese core segments (not shown) can be cut directly from the cheese brick 26 without first cutting a full cheese core 12. The term “cheese core” used herein means both the cheese core 12 and one or more of the cheese core segments (not shown) cut from the cheese core 12 or cut directly from the cheese brick 26.

After the cheese core 12 is provided, the cheese core 12 can be hardened in preparation for insertion into the cored pepperoni log 10. Some cheeses are naturally very hard, and do not require this step. However, many cheeses are too soft and malleable to be pushed into the cored pepperoni log 10 without this step. According to this step, a cheese core 12 can be cooled or frozen for a period of time substantial enough so that it is hard enough to be inserted into the cored pepperoni log 10. With an eight inch long cheese core 12 approximately 0.875 inches in diameter, for instance, the cheese core 12 can be exposed to freezing temperatures—10 degrees Fahrenheit to 32 degrees Fahrenheit for about 2 to 6 hours. The required coldness depends, in part, on the type of cheese used, it's initial hardness, and it's cooling properties.

At this point, a cored pepperoni 10 can be stuffed with a cheese core 12. The cheese core 12 can be inserted by any plausible method. For instance, it can simply be pushed in by hand. Otherwise, tools can be used to assist the insertion.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A cheese-stuffed meat product comprising:
a cured meat having a three-dimensional shape, an outer surface, and a hollow core with at least one opening through said three-dimensional shape and said outer surface; and
at least one cheese core stuffed into at least a portion of said hollow core.

2. The cheese-stuffed meat product of claim 1, wherein said cured meat product is pepperoni.

3. The cheese-stuffed meat product of claim 1, wherein said three-dimensional shape is cylindrical.

4. The cheese-stuffed meat product of claim 3, wherein said cheese core is cylindrically shaped, disposed concentrically within said cured meat to fill said hollow core.

5. The cheese-stuffed meat product of claim 4, wherein said meat product has a first flat end and a second flat end, said cheese core disposed in said hollow core from said first flat end to said second flat end.

6. A method of making cheese-stuffed cured meat, the method comprising:
providing a cored, cured meat product;
providing at least one cheese core; and
stuffing said at least one cheese core into said cored cured meat product.

7. The method of claim 6, wherein said step of providing at least one cheese core comprises removing said cheese core from a cheese brick.

8. The method of claim 6, wherein said step of providing a cored cured meat product further comprises:
providing a solid, three-dimensional, cured meat product; and
coring said solid, three-dimensional, cured meat product.

9. The method of claim 6, wherein said cored cured meat product is provided by forming, curing, and drying said meat product in a casing, wherein said casing is shaped to provide a hollowed portion with at least one opening to said hollowed portion.

10. The method of claim 6, wherein said cheese core is hardened by reducing a temperature of said cheese core.

11. The method of claim 10, wherein said reduced temperature is less than 32 degrees Fahrenheit.

12. The method of claim 8, wherein the step of coring further comprises:
inserting a coring tool into at least a portion of said solid, three-dimensional, cured meat product to cut a meat core;
removing said coring tool from said three-dimensional, cured meat product; and
removing said meat core from said three-dimensional, cured meat product cut by said coring tool.

13. A cheese-stuffed cured meat food, prepared by the process comprising the steps of:
providing a cored cured meat log;
providing at least one cheese core; and
inserting said at least one cheese core into said cored cured meat log.

14. The cheese-stuffed meat food of claim 13, wherein said step of providing a cored cured meat log further comprises:
providing a solid, three-dimensional, cured meat log; and
coring said solid, three-dimensional, cured meat log.

15. The method of claim 13, wherein said cored cured meat log is provided by forming, curing, and drying said meat in a casing, wherein said casing is shaped to provide a hollowed portion.

16. The method of claim 13, wherein said cheese core is hardened before said step of inserting by reducing a temperature of said cheese core.

17. The method of claim 16, wherein said temperature is less than 15 degrees Fahrenheit.

18. The method of claim 14, wherein the step of coring further comprises:
inserting a coring tool into at least a portion of said solid, three-dimensional, cured meat log to cut said at least a portion;
removing said coring tool from said solid three-dimensional, cured meat log; and
removing said at least a portion of said solid, three-dimensional, cured meat log cut by said coring tool.

19. The method of claim 14, wherein the step of providing a solid, three-dimensional, cured meat log comprises:
providing a solid, cured meat stick with a first end and a second end; and
cutting off said first end and said second end.

20. The method of claim 14, wherein the step of providing a solid, three-dimensional, cured meat log comprises:
providing a solid, cured meat stick; and
cutting said solid, cured meat stick into one or more cured meat stick segments.
